(19) United States
(12) Patent Application Publication
(10) Pub. No.: US 2017/0032773 A1
(43) Pub. Date: Feb. 2, 2017

(54) Collapsible, Portable, and Stable Instrument Stand

(71) Applicant: Charles Reginald Smith, IV, Yukon, OK (US)

(72) Inventor: Charles Reginald Smith, IV, Yukon, OK (US)

(21) Appl. No.: 15/222,912

(22) Filed: Jul. 28, 2016

Related U.S. Application Data
(60) Provisional application No. 62/197,708, filed on Jul. 28, 2015.

(51) Int. Cl. G10G 5/00; F16M 11/38

(52) U.S. Cl. CPC G10G 5/00; F16M 11/38

(57) ABSTRACT

An instrument stand that is collapsible, portable, and stable. The instrument stand includes a first support and a second support. The first support and the second support each include a wing-shaped body and an instrument-receiving cavity. The wing-shaped body includes a fixed end, a free end, a top edge portion, a bottom edge portion, an inner surface, and an outer surface. The fixed end of the first support is adjacently and hingedly connected to the fixed end of the second support, creating a V-shaped structure. The instrument-receiving cavity receives a held instrument and traverses through the top edge portion. Additionally, the instrument-receiving cavity traverses through the wing-shaped body from the outer surface to the inner surface, adjacent to the free end. The first support and the second support are identical and are mirrored through a sagittal plane to ensure adequate support and stability for the held instrument.

The current application claims a priority to the U.S. Provisional Patent application Ser. No. 62/197,708 filed on Jul. 28, 2015.

### FIELD OF THE INVENTION

The present invention relates generally to musical instrument stands and holders.

More specifically, the present invention is a collapsible, portable, and stable instrument stand. While generally used to hold a stringed instrument, such as a guitar or bass, the present invention may also be used to hold other types of instruments including, but not limited to, a trumpet, a trombone, a flute, and more.

### BACKGROUND OF THE INVENTION

Instrument stands are objects used to prop up or hold musical instruments. These devices are important as musicians commonly lean their instruments against walls, chairs, or other objects which do not provide the proper support, allowing them to easily be knocked over and damaged in unfortunate circumstances. While standard instrument stands keep the object static, it is not uncommon for the stand itself to be knocked over by a person or moving object. Another problem with the aforementioned devices is that they are often bulky in shape, cumbersome, and difficult to store.

It is therefore an objective of the present invention to introduce a foldable, portable, stable, and durable instrument stand. The present invention is generally used to hold a stringed instrument, such as a guitar or bass, but may also be used to hold other types of instruments including, but not limited to, a trumpet, a trombone, a flute, and more. Unlike traditional guitar stands or similar devices, the present invention is small enough to fit in an instrument case or even a pants pocket. The present invention is also light weight yet durable. Resultantly, the present invention does not ware down from frequent use. As well, the present invention may be easily operable with only one hand.

The present invention is shaped and configured to use the weight of the instrument to provide an extreme stable and almost entirely tip-proof supporting device. When held, the instrument may lean forward to such a degree that all existing stands would otherwise let the instrument fall and become damage, however, the present invention returns the instrument to the original safe starting point. When not in use, the present invention folds flat for easy transportation and storage.

### BRIEF DESCRIPTION OF THE DRAWINGS

FIG. 1 is a perspective view of the present invention in an open configuration.

FIG. 2 is a top view of the present invention in the open configuration.

FIG. 3 is a perspective view of the present invention in a collapsed configuration.

FIG. 4 is a side view of the present invention in the collapsed configuration.

FIG. 5 is an alternative perspective view of the present invention and a held instrument.

### DETAIL DESCRIPTIONS OF THE INVENTION

All illustrations of the drawings are for the purpose of describing selected versions of the present invention and are not intended to limit the scope of the present invention.

The present invention is a collapsible, portable, stable, and durable instrument stand. The present invention is generally used to hold a stringed instrument, such as a guitar, but may also be used to hold other types of instruments including, but not limited to, trumpets, trombones, flutes, and more. Unlike other guitar stands or similar devices, the present invention is small enough to fit in an instrument case or even a pants pocket. The present invention is shaped and configured to use the weight of the instrument to support said instrument with extremely stability in an almost entirely tip proof fashion. When held, the instrument may lean forward to such a degree that all existing stands would otherwise let the instrument fall and become damage, however, the present invention returns the instrument to its original safe starting point. The present invention may be positioned into two main configurations, an open configuration and a collapsed configuration. The open configuration is designed to receive and support the instrument. The collapsed configuration is designed for transportation and storage purposes of the present invention.

Before explaining at least one embodiment of the present invention in detail, it is to be understood that the present invention is not limited in its application to the details of the components and arrangements as described or illustrated. It is also to be understood that the phrasing and terminology employed herein are for the purpose of description and should not be regarded as limiting. As such, the present invention is primarily used to hold musical instruments, but the present invention may be applied to many other settings, situations, and scenarios, being used as a lap top stand, amplifier stand, and a flat screen television stand, while also having use in the automotive industry, restaurant industry, gardening industry, and more.

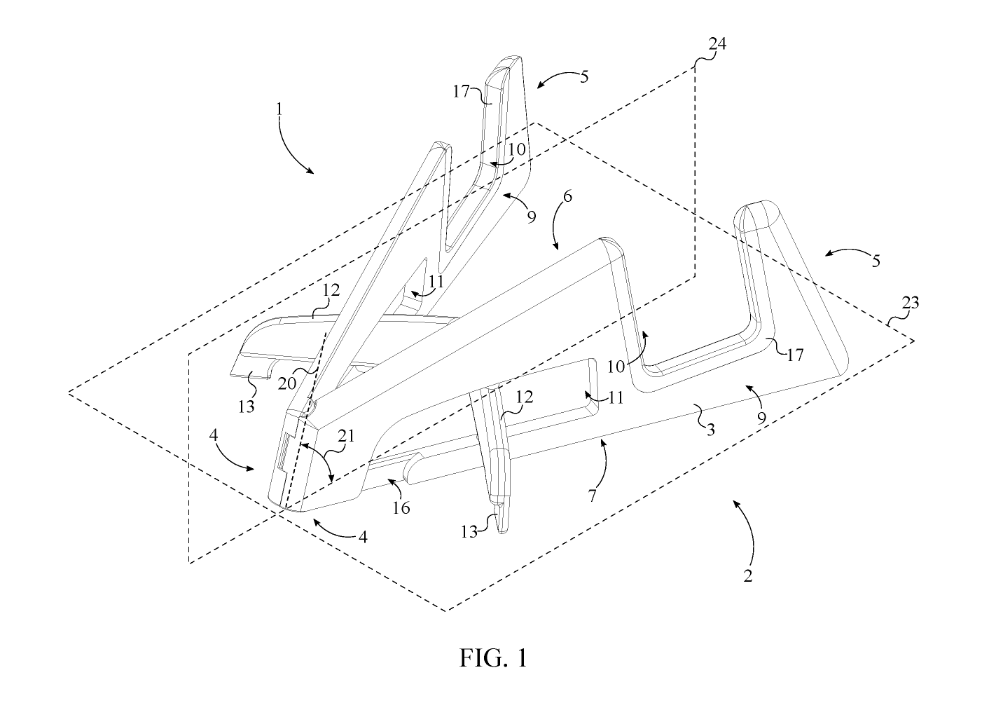

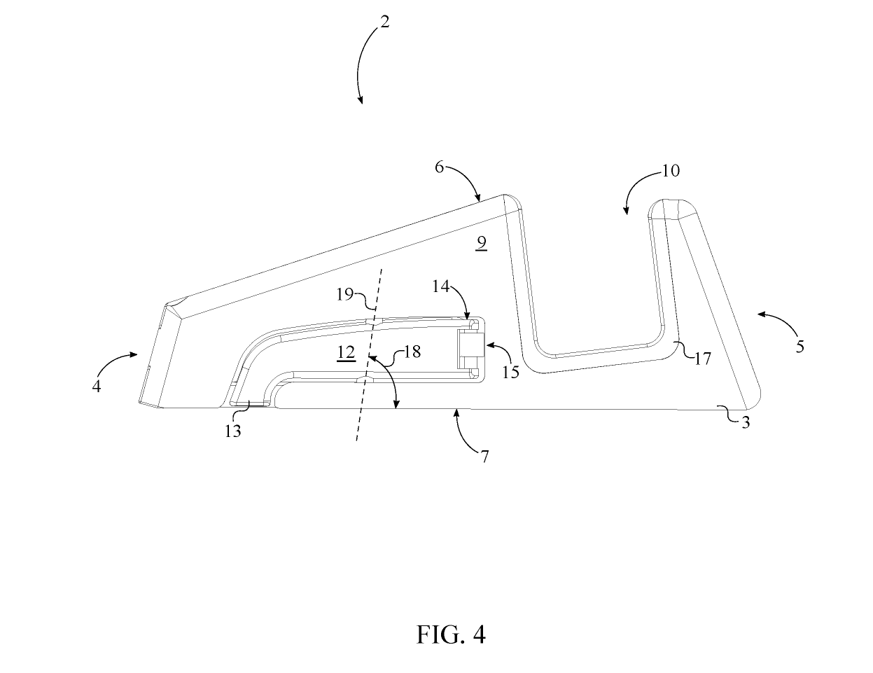

Referring to FIG. 1, in the simplest embodiment the present invention comprises a first support 1 and a second support 2. The first support 1 receives and provides stability to a first portion of a held instrument, a first engagement point. The second support 2 receives and provides stability to a second portion of the held instrument, a second engagement point. These two engagement points provide vertical support as well as lateral support for the held instrument, thus significantly securing the held instrument in a semi-vertical orientation. The first support 1 and the second support 2 are identical in design with each comprising a wing-shaped body 3 and an instrument-receiving cavity 10. The wing-shaped body 3 is a rigid component that is shaped similar to an elongated trapezoid which supports the held instrument, as seen in FIG. 4. More specifically, the wing-shaped body 3 comprises a fixed end 4, a free end 5, a top edge portion 6, a bottom edge portion 7, an inner surface 8, and an outer surface 9. The fixed end 4 of the first support 1 is adjacently and hingedly connected to the fixed end 4 of the second support 2, allowing the first support 1 and the second support 2 to rotate and be positioned at an angle relative to each other. It is preferred that a piano hinge is utilized for the hinge connection between the fixed end 4 of the first support 1 and the fixed end 4 of the second support 2, although alternative mechanisms may also be utilized. As a result, the first support 1 and the second support 2 are mirrored through a sagittal plane 24 of the present invention. The sagittal plane 24 divides the present invention into a left side and a right side, wherein the left side is a mirror of the right side. The symmetric aspect of the present invention is important in ensuring equal support being applied to the held instrument at the first engagement point and the second engagement point, thus increasing the overall stability of the held instrument. It is preferred that the wing-shaped body 3 is tapered from the free end 5 to the fixed, as seen in FIG. 4, in order to reduce the overall weight and improve the portability of the present invention.

The instrument-receiving cavity 10 traverses into the wing-shaped body 3 from the top edge portion 6 and traverses through the wing-shaped body 3 from the outer surface 9 to the inner surface 8 as seen in FIG. 1 to yield a recessed region. The instrument-receiving cavity 10 is positioned adjacent to the free end 5 for added stability of the held instrument. When viewed from the side perspective, the instrument-receiving cavity 10 is preferably an elongated rectangle that is oriented at an angle relative to the bottom edge portion 7. In particular, the instrument-receiving cavity 10 is angled from the free end 5 towards the fixed end 4. The aforementioned orientation and positioning of the instrument-receiving cavity 10 allows the present invention to utilize the weight of the held instrument as a counter-moment in order to prevent the held instrument from tipping backwards or forwards. In particular, when the held instrument is positioned within the instrument-receiving cavity 10, the held instrument naturally leans towards the fixed end 4, applying a portion of body weight onto the wing-shaped body 3. This applies a force onto the wing-shaped body 3 that in turn causes a counter moment to be generated and applied onto the held instrument, thus preventing the held instrument from tipping backwards towards the fixed end 4. A similar process occurs if the held instrument leans towards the free end 5 of the wing-shaped boy, thus preventing the held instrument from tipping over forwards towards the free end 5. As a result, if the held instrument is tipped forward or backwards, the shape of the instrument-receiving cavity 10 provides appropriate counter forces, causing the held instrument to fall safely back into place, resting in a static position.

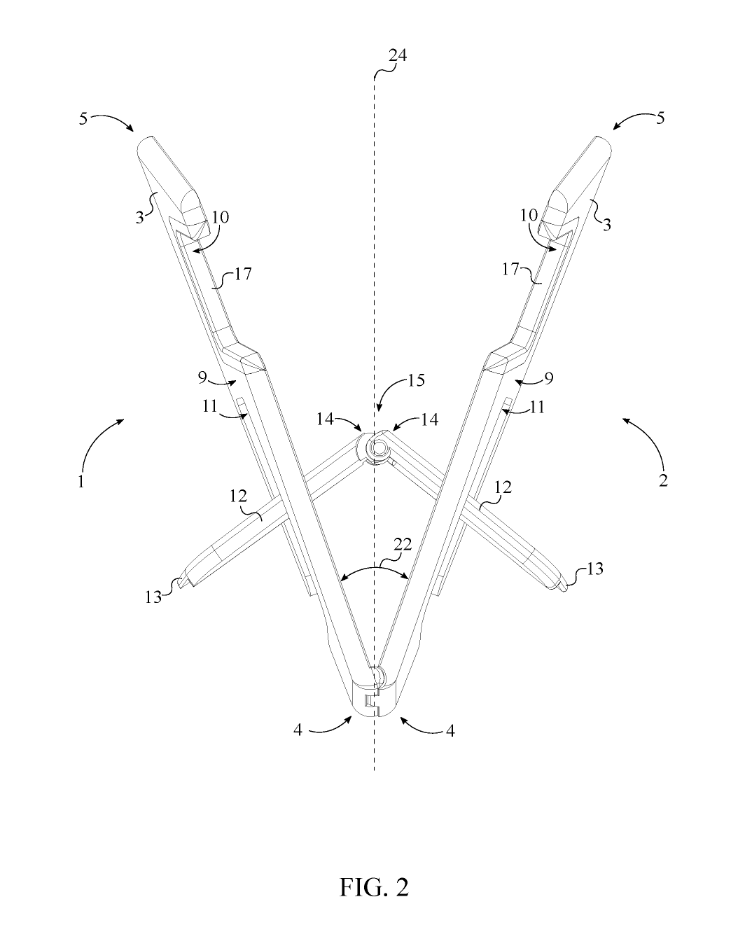

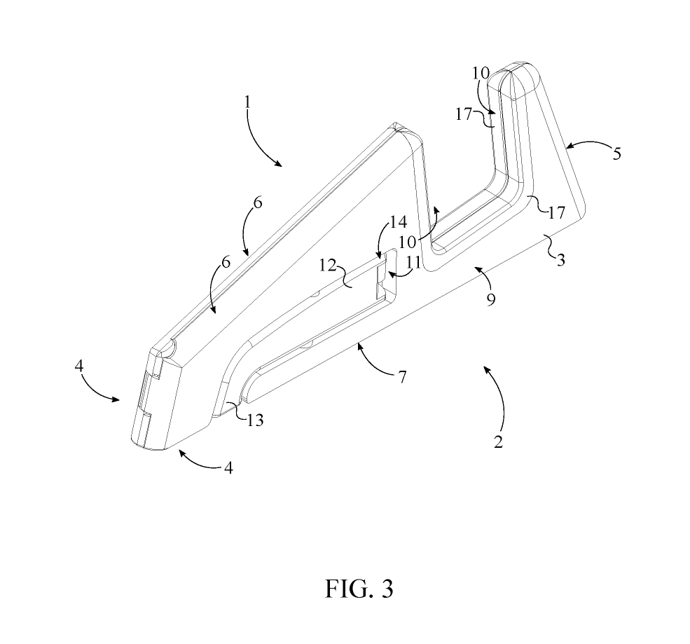

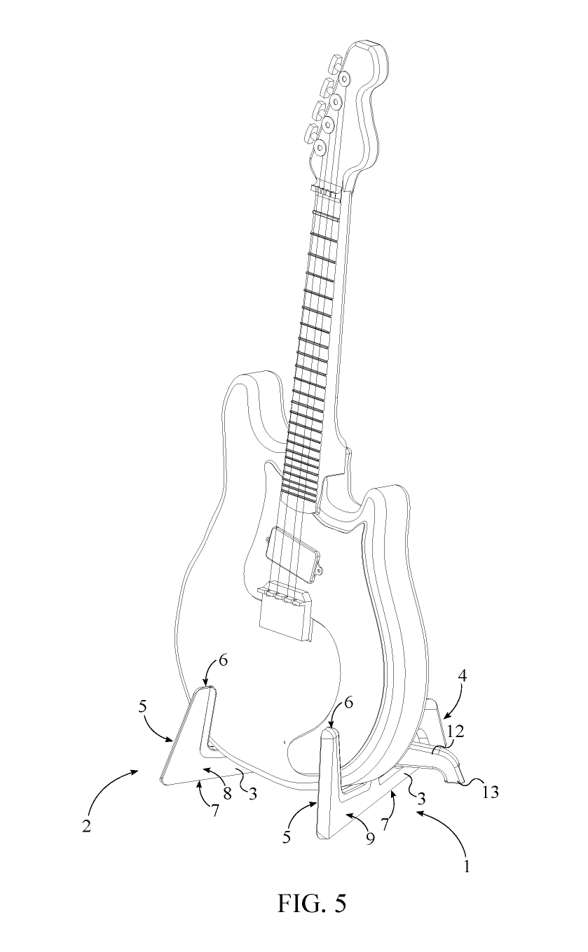

Referring to FIG. 2, in the open configuration, the first support 1 and the second support 2 are positioned away from each other in order to receive the held instrument. In particular, the first support 1 is positioned at a second acute angle 22 with the second support 2 in order to yield a V-like shape when viewed from the top. In order to utilize the present invention, the held instrument is simply held in a vertical orientation and lowered until the held instrument is positioned within instrument-receiving cavity 10 of the first support 1 and the instrument-receiving cavity 10 of the second support 2 as seen in FIG. 5. In order to ensure that the first support 1 stays at the second acute angle 22 with the second support 2, a self-stopping hinge may be used for the hinge connection between the fixed end 4 of the first support 1 and the fixed end 4 of the second support 2. Alternative methods and mechanisms may be used as well to prevent the first support 1 and the second support 2 from moving past a maximizing arc length relative to each other, i.e. the second acute angle 22. In one embodiment, a locking brace is used to connect the first support 1 and the second support 2, for example a tether rope. Referring to FIG. 3, in the collapsed configuration the present invention is ideal for transportation and storage. In the collapsed configuration the first support 1 and the second support 2 are positioned adjacent to each other to yield a small profile, ideal for carrying the present invention in an instrument case or the user's pocket. In particular, the inner surface 8 of the first support 1 is positioned adjacent and parallel to the inner surface 8 of the second support 2.

Referring to FIG. 1, in the preferred embodiment of the present invention, the hinge connection between the first support 1 and the second support 2 is vertically angled to yield a more stable open configuration. In particular, a support rotation axis 20 of the hinge connection between the fixed end 4 of the first support 1 and the fixed end 4 of the second support 2 is oriented at a first acute angle 21 with a base plane 23; wherein the base plane 23 is formed by the bottom edge portion 7 of the first support 1 and the bottom portion of the second support 2. Additionally, the support rotation axis 20 is coincident with the sagittal plane 24 to ensure that the present invention is symmetric when positioned into the open configuration. Furthermore, the support rotation axis 20 is oriented towards the free end 5 of the first support 1 and the free end 5 of the second support 2. Resultantly, when the present invention is positioned into the open configuration, the first support 1 and the second support 2 are oriented towards each other in a concave fashion. This increases the stability of the present invention as the aforementioned orientation creates a wide base; a distance between the bottom edge portion 7 of the first support 1 and the bottom edge portion 7 of the second support 2 being greater than a distance between the top edge portion 6 of the first support 1 and the stop edge portion 6 of the second support 2.

Referring to FIG. 1, in the preferred embodiment of the present invention, the first support 1 and the second support 2 each further comprise a member-receiving slot 11, a horizontal brace member 12, a vertical support leg 13, and linking end-cap 14. The aforementioned components provide additional support for the held instrument and act as the locking brace. The member-receiving slot 11 traverses through the wing-shaped body 3 from the outer surface 9 to the inner surface 8 and is sized/shaped to receive the horizontal brace member 12. Additionally, the member-receiving slot 11 is positioned in between the instrument-receiving cavity 10 and the fixed end 4. The horizontal brace member 12 is positioned within the member-receiving slot 11 and is rotatably mounted to the wing-shaped body 3. A brace rotation axis 19 of the rotatable connection between the horizontal brace member 12 and the wing-shaped body 3 is preferably oriented at a third acute angle 18 with the bottom edge portion 7. This allows the horizontal brace member 12 to be positioned at an angle with the wing-shaped body 3 as well as be positioned flush with the wing-shaped body 3. The vertical support leg 13 is adjacently and perpendicularly connected to the horizontal brace member 12 and provides an additional point of contact with the surface the present invention is sitting on. All-together, this yields five points of contact with the surface the present invention is sitting on.

The linking end-cap 14 is adjacently connected to the horizontal brace member 12, opposite the vertical support leg 13. Additionally, the linking end-cap 14 of the first support 1 is connected to the linking end-cap 14 of the second support 2 through a pivot joint 15. The pivot joint 15 ensures that in the open configuration, the first support 1 and the second support 2 do not travel past the second acute angle 22 as mentioned above. The pivot joint 15 is utilized in this case instead of a hinge joint in order to allow for adduction and abduction movement for the horizontal brace member 12. This important as the angled orientation of the support rotation axis 20 causes, in the open configuration, the horizontal brace member 12 of the first support 1 to move relative to the horizontal brace member 12 of the second support 2 along more than one degree of freedom, more than one direction. The pivot joint 15 accounts for this movement. In the preferred embodiment, the pivot joint 15 is a modified hinge joint which allows for an additional degree of freedom. In particular, the modified hinge joint comprises a first hinge portion, a second hinge portion, and a pin. The first hinge portion is attached to the linking end-cap 14 of the first support 1 and the second hinge portion is attached to the linking end-cap 14 of the second support 2. The pin traverses through the first hinge portion and the second hinge portion. Additionally, the second hinge portion includes an oblong hole instead of a straight hole, which allows the pin to laterally move and rotate relative to the second hinge portion.

Referring to FIG. 1 and FIG. 2, in the open configuration for the preferred embodiment of the present invention, the first support 1 and the second support 2 are positioned away from each other in order to receive the held instrument. The first support 1 is positioned at the second acute angle 22 with the second support 2 in order to yield a V-like shape when viewed from the top. Additionally, the linking end-cap 14 of the first support 1 is positioned in between the wing-shaped body 3 of the first support 1 and the wing-shaped body 3 of the second support 2. Similarly, the linking end-cap 14 of the second support 2 is positioned in between the wing-shaped body 3 of the first support 1 and the wing-shaped body 3 of the second support 2. The pivot joint 15, the horizontal brace member 12 of the first support 1, and the horizontal brace member 12 of the second support 2 act as the locking brace in order to prevent the first support 1 and the second support 2 from being positioned past the second acute angle 22 relative to each other when the held instrument is positioned within the present invention.

Referring to FIG. 3 and FIG. 4, in the collapsed configuration for the preferred embodiment of the present invention, the first support 1 and the second support 2 are positioned adjacent to each other to yield a small profile, ideal for carrying the present invention in an instrument case or the user's pocket. In particular, the inner surface 8 of the first support 1 is positioned adjacent and parallel to the inner surface 8 of the second support 2. Additionally, the horizontal brace member 12 is positioned completely within the member-receiving slot 11 until the horizontal brace member 12 is oriented parallel to the bottom edge portion 7 in a flush manner. To further ensure a flush fit for the vertical support leg 13, the first support 1 and the second support 2 each further comprise a leg-receiving cavity 16. The leg-receiving cavity 16 laterally traverses into the wing-shaped body 3 from the outer surface 9 a distance equal to the width of the vertical support leg 13. The leg-receiving cavity 16 is also shaped/sized and positioned to receive the vertical support leg 13. In particular, the leg-receiving cavity 16 is positioned opposite the top edge portion 6, across the member-receiving slot 11. In the collapsed configuration, the vertical support leg 13 is positioned within the leg-receiving cavity 16, flush with the outer surface 9.

In the preferred embodiment of the present invention, the first support 1 and the second support 2 each further comprise a cushioned lining 17. The inner surface 8 of the instrument-receiving cavity 10 is covered by the cushioned lining 17 in order to prevent the wing-shaped body 3 from scratching, damaging, and scuffing the regions of the held instrument within the instrument-receiving cavity 10. In particular, the cushioned lining 17 is a strip of soft material, such as rubber or cloth, that is perimetrically positioned against the instrument-receiving cavity 10 and is adjacently connected to the wing-shaped body 3. The thickness and material composition of the cushioned lining 17 is subject to change in order to meet the needs of the user or the handling requirements of the held instrument.

Although the invention has been explained in relation to its preferred embodiment, it is to be understood that many other possible modifications and variations can be made without departing from the spirit and scope of the invention as hereinafter claimed.

What is claimed is:

1. A collapsible, portable, and stable instrument stand comprises:
a first support;
a second support;
a sagittal plane;
the first support and the second support each comprise a wing-shaped body and an instrument-receiving cavity;
the wing-shaped body comprises a fixed end, a free end, a top edge portion, a bottom edge portion, an inner surface, and an outer surface;
the fixed end of the first support being adjacently and hingedly connected to the fixed end of the second support;
the instrument-receiving cavity traversing into the wing-shaped body from the top edge portion;
the instrument-receiving cavity traversing through the wing-shaped body from the outer surface to the inner surface;
the instrument-receiving cavity being positioned adjacent to the free end; and
the first support and the second support being mirrored through the sagittal plane.

2. The collapsible, portable, and stable instrument stand as claimed in claim 1 comprises:
the first support and the second support each further comprise a member-receiving slot, a horizontal brace member, a vertical support leg, and a linking end-cap;
the member-receiving slot being positioned in between the instrument-receiving cavity and the fixed end;
the member-receiving slot traversing through the wing-shaped body from the outer surface to the inner surface;
the vertical support leg being adjacently and perpendicularly connected to the horizontal brace member;
the linking end-cap being adjacently connected to the horizontal brace member, opposite the vertical support leg;
the horizontal brace member being positioned within the member-receiving slot;
the horizontal brace member being rotatably mounted to the wing-shaped body; and
the linking end-cap of the first support being connected to the linking end-cap of the second support through a pivot joint.

3. The collapsible, portable, and stable instrument stand as claimed in claim 2, wherein a brace rotation axis of the rotatable connection between the horizontal brace member and the wing-shaped body being at a third acute angle with the bottom edge portion.

4. The collapsible, portable, and stable instrument stand as claimed in claim 1 comprises:
a base plane being formed by the bottom edge portion of the first support and the bottom edge portion of the second support;
a support rotation axis of the hinge connection between the fixed end of the first support and the fixed end of the second support being at a first acute angle with the base plane;
the support rotation axis being coincident with the sagittal plane; and
the support rotation axis being oriented towards the free end of the first support and the free end of the second support.

5. The collapsible, portable, and stable instrument stand as claimed in claim 2 comprises:
the first support and the second support being configured into an open configuration;
the first support being at a second acute angle with the second support;
the linking end-cap of the first support being positioned in between the wing-shaped body of the first support and the wing-shaped body of the second support;
the linking end-cap of the second support being positioned in between the wing-shaped body of the first support and the wing-shaped body of the second support; and
the vertical support leg being positioned adjacent to the outer surface, opposite the inner surface.

6. The collapsible, portable, and stable instrument stand as claimed in claim 2 comprises:
the first support and the second support being configured into a collapsed configuration;
the first support and the second support each further comprise a leg-receiving cavity;
the leg-receiving cavity laterally traversing into the wing-shaped body from the outer surface;
the leg-receiving cavity being positioned opposite the top edge portion, across the member-receiving slot;
the inner surface of the first support being positioned adjacent and parallel to the inner surface of the second support;
the horizontal brace member being oriented parallel to the bottom edge portion; and
the vertical support leg being positioned within the leg-receiving cavity, flush with the outer surface.

7. The collapsible, portable, and stable instrument stand as claimed in claim 1 comprises:
the first support and the second support each further comprises a cushioned lining;
the cushioned lining being perimetrically positioned against the instrument-receiving cavity; and
the cushioned lining being adjacently connected to the wing-shaped body.

8. The collapsible, portable, and stable instrument stand as claimed in claim 1, wherein the wing-shaped body is tapered from the free end to the fixed end.

9. The collapsible, portable, and stable instrument stand as claimed in claim 1 comprises:
the first support and the second support being configured into an open configuration; and
the first support being at a second acute angle with the second support.

10. The collapsible, portable, and stable instrument stand as claimed in claim 1 comprises:
the first support and the second support being configured into a collapsed configuration; and
the inner surface of the first support being positioned adjacent and parallel to the inner surface of the second support.

11. A collapsible, portable, and stable instrument stand comprises:
a first support;
a second support;
a sagittal plane;
the first support and the second support each comprise a wing-shaped body, an instrument-receiving cavity, a member-receiving slot, a horizontal brace member, a vertical support leg, and a linking end-cap;
the wing-shaped body comprises a fixed end, a free end, a top edge portion, a bottom edge portion, an inner surface, and an outer surface;
the fixed end of the first support being adjacently and hingedly connected to the fixed end of the second support;
the instrument-receiving cavity traversing into the wing-shaped body from the top edge portion;
the instrument-receiving cavity traversing through the wing-shaped body from the outer surface to the inner surface;
the instrument-receiving cavity being positioned adjacent to the free end;
the first support and the second support being mirrored through the sagittal plane;
the member-receiving slot being positioned in between the instrument-receiving cavity and the fixed end;
the member-receiving slot traversing through the wing-shaped body from the outer surface to the inner surface;
the vertical support leg being adjacently and perpendicularly connected to the horizontal brace member;
the linking end-cap being adjacently connected to the horizontal brace member, opposite the vertical support leg;
the horizontal brace member being positioned within the member-receiving slot;
the horizontal brace member being rotatably mounted to the wing-shaped body; and
the linking end-cap of the first support being connected to the linking end-cap of the second support through a pivot joint.

12. The collapsible, portable, and stable instrument stand as claimed in claim 12, wherein a brace rotation axis of the rotatable connection between the horizontal brace member and the wing-shaped body being at a third acute angle with the bottom edge portion.

13. The collapsible, portable, and stable instrument stand as claimed in claim 12 comprises:
a base plane being formed by the bottom edge portion of the first support and the bottom edge portion of the second support;
a support rotation axis of the hinge connection between the fixed end of the first support and the fixed end of the second support being at a first acute angle with the base plane;
the support rotation axis being coincident with the sagittal plane; and
the support rotation axis being oriented towards the free end of the first support and the free end of the second support.

14. The collapsible, portable, and stable instrument stand as claimed in claim 12 comprises:
the first support and the second support being configured into an open configuration;
the first support being at a second acute angle with the second support;
the linking end-cap of the first support being positioned in between the wing-shaped body of the first support and the wing-shaped body of the second support;
the linking end-cap of the second support being positioned in between the wing-shaped body of the first support and the wing-shaped body of the second support; and
the vertical support leg being positioned adjacent to the outer surface, opposite the inner surface.

15. The collapsible, portable, and stable instrument stand as claimed in claim 12 comprises:
the first support and the second support being configured into a collapsed configuration;
the first support and the second support each further comprise a leg-receiving cavity;
the leg-receiving cavity laterally traversing into the wing-shaped body from the outer surface;
the leg-receiving cavity being positioned opposite the top edge portion, across the member-receiving slot;
the inner surface of the first support being positioned adjacent and parallel to the inner surface of the second support;
the horizontal brace member being oriented parallel to the bottom edge portion; and
the vertical support leg being positioned within the leg-receiving cavity, flush with the outer surface.

16. The collapsible, portable, and stable instrument stand as claimed in claim 12 comprises:
the first support and the second support each further comprises a cushioned lining;
the cushioned lining being perimetrically positioned against the instrument-receiving cavity; and
the cushioned lining being adjacently connected to the wing-shaped body.

17. The collapsible, portable, and stable instrument stand as claimed in claim 12, wherein the wing-shaped body is tapered from the free end to the fixed end.
